(19) United States
(12) Patent Application Publication
(10) Pub. No.: US 2005/0027730 A1
(43) Pub. Date: Feb. 3, 2005

(54) Method and system for storing compressed files

(76) Inventor: Steffan Bansemer, Berlin (DE)

Correspondence Address: Steffan Bansemer, Regattastr. 60, Berlin, 12527, DE

(21) Appl. No.: 10/628,112

(22) Filed: Jul. 28, 2003

(51) Int. Cl. G06F 17/00

(52) U.S. Cl. 707/101

(57) ABSTRACT

A method and system for storing compressed files are provided. Various file compressing formats like older versions of the PKZIP-Format have limitations for the amount of compressed files or the total file size of the created archive that contains these files. On the other hand some storage media do not support single files larger than a specific size. To support the compression of many files and keep the limits of the compression or medium format this invention provides a method to store compressed files which number or resulting compressed size would exceed given limits.

### FIELD OF THE INVENTION

This invention relates generally to computer systems and, more particularly, to a method and system to store compressed files in a way to keep the limits of given compression formats or storage media formats.

### BACKGROUND OF THE INVENTION

If a software application wants to store compressed files on a specific medium created with a specific file compression format it may has to keep the given limits. For example if you want to back up all files on a hard drive in one single compressed archive a software application can only add 65,536 files to an old PKZIP compression format archive and the created archive cannot have a file size larger than 2 Gigabyte. On the other hand some media formats like DVD-R do not allow single files stored larger than 2 Gigabyte. To keep the limits of the compression format and the destination storage medium this invention provides a method to keep the limits but to compress as much files as possible. It is based on the fact, that an average path (folder) on a hard drive never does contain more than 65,536 files but the amount of files stored on the hard drive can amount to more than 65,536. With this method all files can be compressed and stored on the destination medium.

### SUMMARY OF THE INVENTION

According to the present invention, this method and system provides a way to store compressed files to keep the limits of the given compression format or the limit of the destination medium. The compressed files are stored in single archives based on the source path of the files. The created archives can be stored then in an according path structure or in a single destination path but each numbered. This allows storing more compressed files than various compression formats or media formats would allow because of their according limitations.

1. A method in a computer system for storing compressed files on various media to keep the limits of given compression formats or media formats, the method comprising the computer-implemented steps of:
creating a list of files to include in the data compression process;
sorting these files by their pathname;
creating for each pathname a single compressed archive of any format that contains all files from that path;
storing the created archive to an according path (folder);
repeating these steps until all files are compressed and stored on the destination medium;

2. The method of claim 1 wherein the destination medium is a CD-R.

3. The method of claim 1 wherein the destination medium is a CD-R/W.

4. The method of claim 1 wherein the destination medium is a DVD-R or DVD+R.

5. The method of claim 1 wherein the destination medium is a DVD-R/W or DVD+R/W.

6. The method of claim 1 wherein the destination medium is a DVD-RAM.

7. The method of claim 1 wherein the destination medium is a hard drive.

8. The method of claim 1 wherein the destination medium is a network drive.

9. The method of claim 1 wherein the destination medium is a removable media like floppy disks.

10. The method of claim 1 wherein the destination medium is a USB Flash drive.

11. The method of claim 1 wherein the created archive is numbered and stored in a single path (folder) on the destination medium.
